(19) United States
(12) Patent Application Publication
(10) Pub. No.: US 2025/0030775 A1
(43) Pub. Date: Jan. 23, 2025

(54) ENHANCED SYSTEMS AND METHODS FOR PERSISTENT NETWORK PATHS

(71) Applicant: Level 3 Communications, LLC, Denver, CO (US)

(72) Inventors: Steve WAKUMOTO, Golden, CO (US); Dayne ALLEN, Broomfield, CO (US); Zhuo JING, Erie, CO (US); Efren MALDONADO, Highlands Ranch, CO (US); Hoang TRAN, Thornton, CO (US); Brian SANNIOLA, Parker, CO (US)

(73) Assignee: Level 3 Communications, LLC, Denver, CO (US)

(21) Appl. No.: 18/772,029

(22) Filed: Jul. 12, 2024

Related U.S. Application Data
(60) Provisional application No. 63/515,073, filed on Jul. 21, 2023.

(51) Int. Cl. H04L 67/51; H04L 61/103; H04L 101/622

(52) U.S. Cl. CPC H04L 67/51; H04L 61/103; H04L 2101/622

(57) ABSTRACT

This disclosure describes systems, methods, and devices related to determining persistent service paths between provider edge devices and customer edge devices. A device may identify a service identifier associated with a service provided by a communication network; identify, based on the service identifier and traffic data of the communication network, one or more first adjacencies between provider edge devices, of the communication network, using a service indicated by the service identifier; identify, based on the service identifier and traffic data of the communication network, one or more second adjacencies between the provider edge devices and customer edge devices using the service; and map, based on the one or more first adjacencies and the one or more second adjacencies, a persistent service path between a customer edge device of the customer edge devices and a provider edge device of the provider edge devices.

### CROSS-REFERENCE TO RELATED APPLICATION

This application claims priority to U.S. Provisional Patent Application No. 63/515,073, filed Jul. 21, 2023, the entire content of which is incorporated herein by reference for all purposes. This application is also related U.S. Pat. No. 10,560,284, titled “SYSTEM AND METHODS FOR MAPPING A NETWORK SERVICE PATH,” the entire content of which is incorporated herein by reference for all purposes.

### TECHNICAL FIELD

Embodiments of the present invention generally relate to devices, systems, and methods for generating and mapping persistent communication network paths between customer premise equipment and communication network resources.

### BACKGROUND

Communications network providers establish communication links between customer premise equipment and network resources. For example, the service provider configures and couples routing elements to generate a communication link and extend network services to customer premise equipment. A network service path defines the order or manner in which devices are mapped in the communication link from the customer premise equipment to network elements of a telecommunications network.

### SUMMARY

A method of determining persistent service paths between provider edge devices and customer edge devices may include: identifying, by at least one processor of a device, a service identifier associated with a service provided by a communication network; identifying, by the at least one processor, based on the service identifier and traffic data of the communication network, one or more first adjacencies between provider edge devices, of the communication network, using a service indicated by the service identifier; identifying, by the at least one processor, based on the service identifier and traffic data of the communication network, one or more second adjacencies between the provider edge devices and customer edge devices using the service; and mapping, by the at least one processor, based on the one or more first adjacencies and the one or more second adjacencies, a persistent service path between a customer edge device of the customer edge devices and a provider edge device of the provider edge devices.

A device for determining persistent service paths between provider edge devices and customer edge devices, the device comprising memory coupled to at least one processor to: identify a service identifier associated with a service provided by a communication network; identify, based on the service identifier and traffic data of the communication network, one or more first adjacencies between provider edge devices, of the communication network, using a service indicated by the service identifier; identify, based on the service identifier and traffic data of the communication network, one or more second adjacencies between the provider edge devices and customer edge devices using the service; and map, based on the one or more first adjacencies and the one or more second adjacencies, a persistent service path between a customer edge device of the customer edge devices and a provider edge device of the provider edge devices.

A system for determining persistent service paths between provider edge devices and customer edge devices may include: the provider edge devices; the customer edge devices; and memory coupled to at least one processor, the at least one processor configured to: identify a service identifier associated with a service provided by a communication network; identify, based on the service identifier and traffic data of the communication network, one or more first adjacencies between the provider edge devices, wherein the provider edges use a service indicated by the service identifier; identify, based on the service identifier and traffic data of the communication network, one or more second adjacencies between the provider edge devices and customer edge devices, wherein the customer edge devices use the service; and map, based on the one or more first adjacencies and the one or more second adjacencies, a persistent service path between a customer edge device of the customer edge devices and a provider edge device of the provider edge devices.

### BRIEF DESCRIPTION OF THE DRAWINGS

FIG. 1 illustrates an exemplary communications network with persistent paths in accordance with one embodiment.

FIG. 2 illustrates an exemplary system for identifying persistent paths in the communications network of FIG. 1 in accordance with one embodiment.

FIG. 3 illustrates an exemplary system for event-driven service health assessment using persistent paths in the communications network of FIG. 1 in accordance with one embodiment.

FIG. 4 is a flowchart illustrating a process for identifying persistent paths in the communications network of FIG. 1 in accordance with one embodiment.

FIG. 5 is a diagram illustrating an example of a computing system that may be used in implementing embodiments of the present disclosure.

### DETAILED DESCRIPTION

Aspects of the present disclosure involve devices, systems, methods, and the like, for generating and mapping persistent communication network paths between customer premise equipment and communication network resources.

Conventionally, network service path mapping requires service providers to maintain an inventory of network devices and, more specifically, interfaces of the network devices. Each interface within the inventory is generally assigned an interface description field and corresponding interface attributes. The use of such inventories is limited in various ways. For example, equipment vendors often limit the size and/or format of interface description fields. Moreover, reliable determination of network service paths depends on the accuracy of the inventory and, as a result, whether network operators consistently and accurately update the inventory. Over time, inaccuracies can arise in the inventory, leading to inaccurate or incomplete network service path determinations. For example, basic human error during data input into the inventory and failure to properly report migration or modification of network equipment (e.g., during system upgrades or in response to outages or equipment failures) can lead to an inaccurate or incomplete inventory. Any subsequent network path determinations based on such a flawed inventory can similarly be inaccurate or incomplete.

In contrast to relying on an inventory, enhanced network service path mapping may rely on actual network traffic. Network service paths may use device address tables with data from network elements, such as medium access control (MAC) layer addresses, to determine which network elements, if any, have interacted with an endpoint device and, as a result, potentially form a part of a network service path associated with the endpoint device. In particular, the database is queried to determine whether the device identifier or attribute has been logged within any of the aggregated network traffic tables. Where the device identifier is logged within network traffic data associated with a certain network element, the network element may be identified as forming a part of the network service path. In this manner, network paths may be built using run-time stitching logic.

However, such use of MAC address tables with run-time stitching logic may apply to a subset of layer-two services, but not others. For example, a MAC address table may be limited to the devices corresponding to the MAC addresses in the table (e.g., limited to what the address table has), and therefore may not be as complete and accurate for establishing a persistent network path as the techniques described herein.

In addition, a service status may occur as a request-driven activity that may launch a sequence of collections, which may lead to a service status. In this manner, a service status may be reactive.

There is therefore a need for a persistent network path that can be used for all layer-two and layer-three services and for event-driven diagnostics.

In one or more embodiments, a communications system may associate a customer service (e.g., ordering) tot an end-to-end network representation in a database for instance access. For example, a persistent path may be based on a service identifier (e.g., edge devices using traffic for a service indicated by the service identifier). Other systems may incur a significant delay in providing a network path because they may compute the path at run-time. In addition, other systems may use a “design” system rather than the actual network data, and therefore may be less accurate than the enhanced systems and methods herein. The enhanced persistent path herein may enable an ability to overlay events (e.g., fault/performance) for near real-time diagnostics, providing a significant improvement over existing techniques.

In one or more embodiments, the enhanced persistent path herein may use network-based adjacency relationships that may be stitched together to generate an end state of provider edge (PE) to customer edge (CE). The individual adjacencies that may be discovered may include, for various interfaces and protocols, including but not limited to, pe_to_mc (provider edge to metro core—metro core referring to a top-tier Ethernet aggregator, for example, which may be high-density, high-performance switches that may aggregate and distribute high volumes of customer traffic, and which may be connected to PE routers to allow traffic to traverse between markets or to the public Internet; and a provider edge referring to where customer services are built at a carrier facility, such as Layer-3 Internet and Layer-3 IP VPN services created on a PE router), mc_to_mc, mc_to_me (me referring to metro edge switch, such as part of a ring architecture which delivers services to a building where customers may be located, for example; metro edge Ethernet switches may be placed in buildings where customer service physical connections may be created as such switches are lower density devices that may operate in a ring configuration to allow a lower cost delivery of services), mc_to_ma (ma referring to metro aggregation, such as a second-tier Ethernet aggregator, which may be integrated as switches into a high-density metro core to allow connectivity of some services), mo_to_nid (e.g., metro off-network to network interface device), ma_to_me, and pe_to_mcpe (mcpe referring to managed customer premise equipment; some customers may use their own CPE typically having a single access port to the carrier Ethernet network and a single port to the customer's network infrastructure, or direct connections to the customer's network devices such as servers, PCs, workstations, etc.). A metro hub may play a similar role to a metro core, allowing an extension of rings to other parts of a market. Metro hubs may connect to metro cores facing a carrier's network and toward rings facing a customer.

In one or more embodiments, a cluster environment may be generated based on the adjacencies, and non-cluster members (e.g., false positives) may be removed. For example, clusters could include adjacencies for a particular network device (e.g., a service router, etc.). The network may guess which service point is next in the path, and may not be dependent on network inventory itself. The MAC addresses of the devices may not be needed to provide device ordering. Diagnostics may lay over a network path, but the path takes time to establish. The enhancements herein reduce the bottleneck and provide an improved network path estimate.

In one or more embodiments, the mo_to_nid adjacency may use a MAC address association from moSp:VLAN505 to find the presence of nidWANMAC (e.g., a MAC address of a wide area network of the nid). The mc_to_ma may refer to using a discovery protocol. mc_to_me may refer to using a rep (resilient Ethernet protocol). pe_to_mc may refer to using couplets (e.g., using interface naming standards where peSp maps to msSp through a common format). mc_to_mc may refer to a bridge domain. A metro hub (mh) adjacency may be used. Route-targets (rt) may be used to identify cluster members. Metro segment-routing and pseudo-wires may be used to identify adjacencies. For some hybrid networks, link layer discovery protocol (LLDP) may be used to identify adjacencies. From the configurations, the network may establish virtual local area network (VLAN) extraction for an outerTag and an innnerTag (e.g., of Ethernet frames, in which the outerTag includes service provider VLAN information, and the innerTag includes VLAN information for service provider customer traffic).

In one or more embodiments, there are multiple criterion for cluster members. For example, if a service point has a parent device that is not a cluster member, the service point also may be excluded (e.g., resulting in a significant reduction in devices). Candidate members, device to IP mapping, and brute force association also may be used to identify cluster members.

In one or more embodiments, a network may associate a persistent path back to an ordering system. The ordering system may not be configured to recognize interfaces (e.g., may need a service identifier). A customer may have service identifiers on various services of the network used by the customer. The network may use the service identifier to determine a user's location and the network services used at the location, then may investigate the services to establish the persistent network path.

In one or more embodiments, by building the persistent network path at batch processing time, the establishment of the network path may be made faster, more accurately, and may enable the ability to overlay events for diagnostics using the path.

In one or more embodiments, the enhanced persistent network path may allow for seeing what the network sees instead of relying on a customer or blueprint (e.g., accounting for a possible change in the network). In this manner, the enhanced network path herein is more complete and accurate, and is generated faster, making it better for detecting whether a customer has issues and where.

In one or more embodiments, configuration data and predefined network architecture rules regarding the interconnection of network elements are accessed to determine the particular order of the network elements of the network service path. Specifically, each network element may have a particular type, function, or other characteristic which defines a predetermined order or position of the network element within a network service path. Architectural rules may then be used to determine the orientation of the elements within a network service path. For example, where a network element of the network service path is identified as a particular type of router, certain predefined architectural rules may define the specific orientation of the router within the network service path. The order of the network elements of the network service path generally refers to the interconnection of the network elements and, as a result, may be defined by physical, logical, or a combination of both physical and logical relationships between network elements.

In one or more embodiments, an algorithm for identifying cluster candidates may include a call for an index, specifying a particular domain, service points (e.g., me, mo, mh—metro hubs, and the like), and search paths. The result of the call may be a number of candidate devices for a persistent path. The candidate devices may be filtered based on a number of criteria. The filtered candidate devices may be used to build a device-to-IP mapping table for border gateway protocol (BGP) neighbors (e.g., based on a vendor and a domain). The result should be a reduced set of candidates. For any network device, the neighboring devices may be identified (e.g., using the device-to-IP mapping table to resolve BGP neighbor IP to BGP neighbor. A network device may have multiple BGP neighbors at respective IP addresses. For identified neighbors, the algorithm may walk a certain distance until another device is found and added as a candidate. For remaining network devices, the candidate list may be reduced to devices that have mo_to_nid associations. From those, an access identifier may be taken from an instance and searched in the mapping table to associate the device to the cluster. For example, a client device may have multiple BGP neighbor devices with respective IP addresses.

In one or more embodiments, a media route target mat be used to find service members on a cluster of network devices. A metro route target may be reused between markets to eliminate “over-matched” service points.

In one or more embodiments, customer services may be decomposed to their path components in a pre-build persisted path database associated by a database. In this manner, the service status may be proactive, predictive, and restorative. Events, such as performance metrics-based thresholds, equipment failures, nature (e.g., flooding), service tickets, and others (e.g., a fiber line cut) may be input to a disposition rules engine that may update a service status database accordingly. A notification engine may notify users of a network, such as by using subscriptions, e-mail/text, a portal, and the like. In some situations, a resolution engine may resolve/mitigate an identified network impairment.

In one or more embodiments, the results of the algorithm for identifying the persistent path may include, for given service identifiers, a peSp, a mcSP, an access identifier (e.g., from the mcSp), and a ceSp, among others.

The above descriptions are for purposes of illustration and are not meant to be limiting. Numerous other examples, configurations, processes, etc., may exist, some of which are described in greater detail below. Example embodiments will now be described with reference to the accompanying figures.

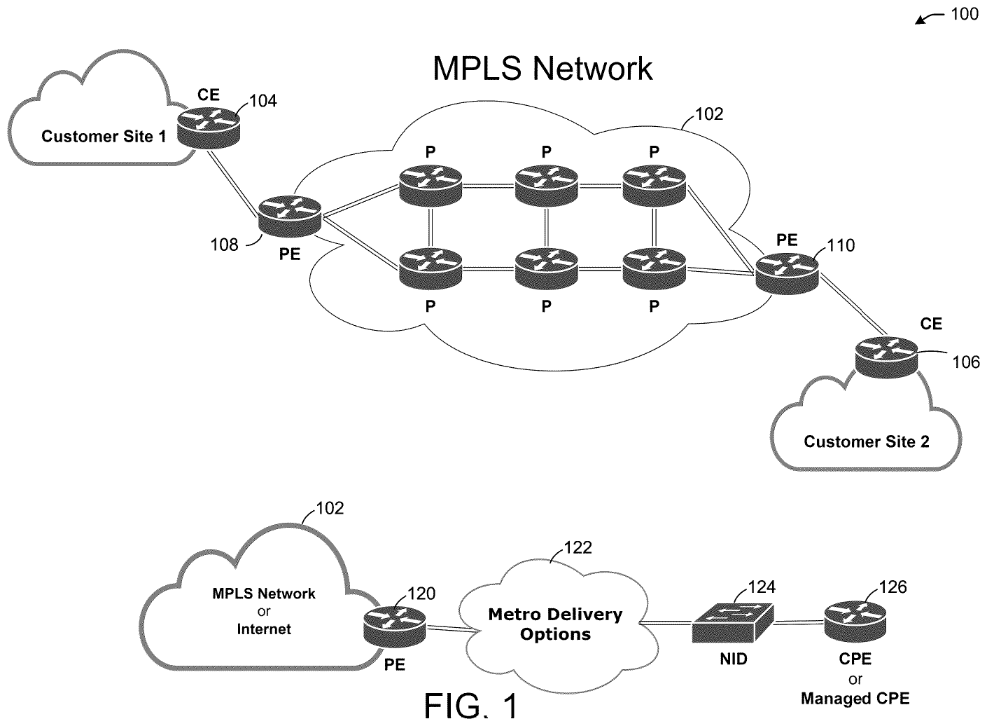

FIG. 1 illustrates an exemplary communications network 100 with persistent paths in accordance with one embodiment.

Referring to FIG. 1, the communications network 100 may include a MPLS network 102 for routing traffic to and from customer sites (e.g., customer site 1 with customer edge CE 104, customer site 2 with customer edge CE 106). Traffic to and from the customer sites may route through provider edges (e.g., PE 108, PE 110). The MPLS network 102 may include provider devices (Ps) for routing the traffic, with the various PEs, CEs, and Ps having respective interfaces.

Still referring to FIG. 1, may route traffic, using one or more PEs 120, to and from metro delivery options 122, which may communicate with NIDs 124 to deliver traffic to and from customer equipment (e.g., CPE 126). A provider may provide the CPE 126 to a customer, such as a residential or commercial customer, which may access the MPLS network 102 via CEs, PEs, and NIDs forming a network path of the devices and their interfaces. Any particular service provided to a customer by the provider may have a service path using a combination of CEs, PEs, and NIDs and their respective interfaces. The enhanced persistent path herein may use network-based adjacency relationships that may be stitched together to generate an end state of provider edge (PE) to customer edge (CE).

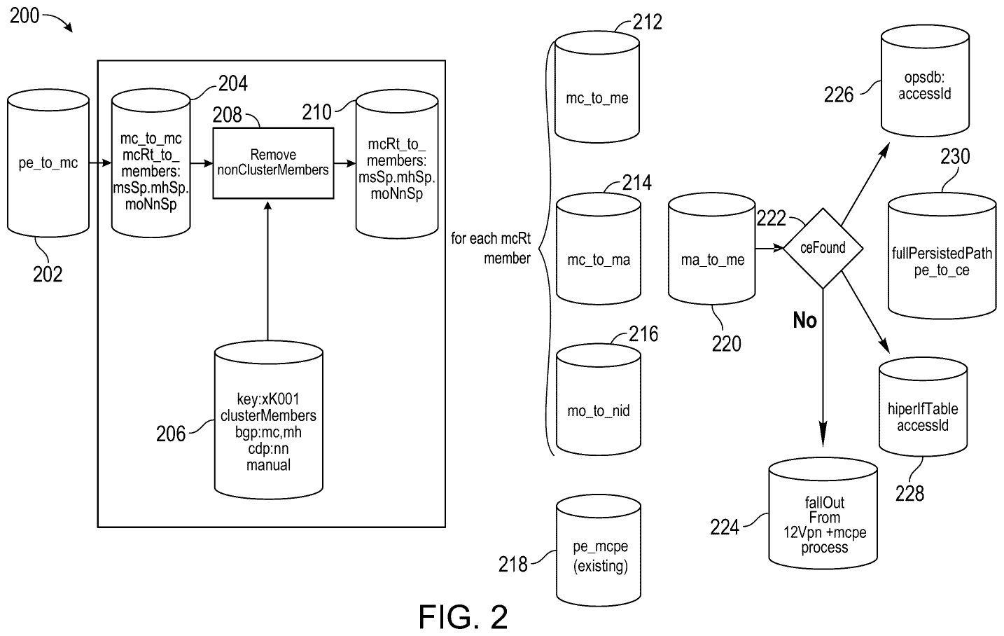

FIG. 2 illustrates an exemplary system 200 for identifying persistent paths in the communications network 100 of FIG. 1 in accordance with one embodiment.

Referring to FIG. 2, the system 200 may include a data storage 202 for pe_to_mc adjacencies. From the metro cores, a data storage 204 may include mc_to_mc, mcRt_to_members: mcSp, mhSp, and moNnSp adjacencies. Using cluster member criteria (e.g., BGP, me, mh, cdp:nn, manual etc.), non-cluster members may be removed 208 and provided to data storage 210 for mcRt_to_members: mcSp, mhSp, and moNnSp, for example.

Still referring to FIG. 2, for each mcRt member in the data storage 210, data storage 212 may include adjacencies for mc_to_me. Data storage 214 may include adjacencies for mc_to_ma. Data storage 216 may include adjacencies for mo_to_nid. In addition, a data storage 218 may include adjacencies for pe_mcpe. A data storage 220 for ma_to_me may input its adjacencies to a ce found 222 analysis (e.g., to determine whether a ce is identified). If not, the adjacency may be input to a data storage 224. If the adjacencies to a ce are found at 222, a database 226 and/or a data storage 228 may store the access identifiers. A data storage 230 may store a full persisted data path (e.g., pe_to_ce) based on the access identifier and the corresponding adjacencies in the respective data storage.

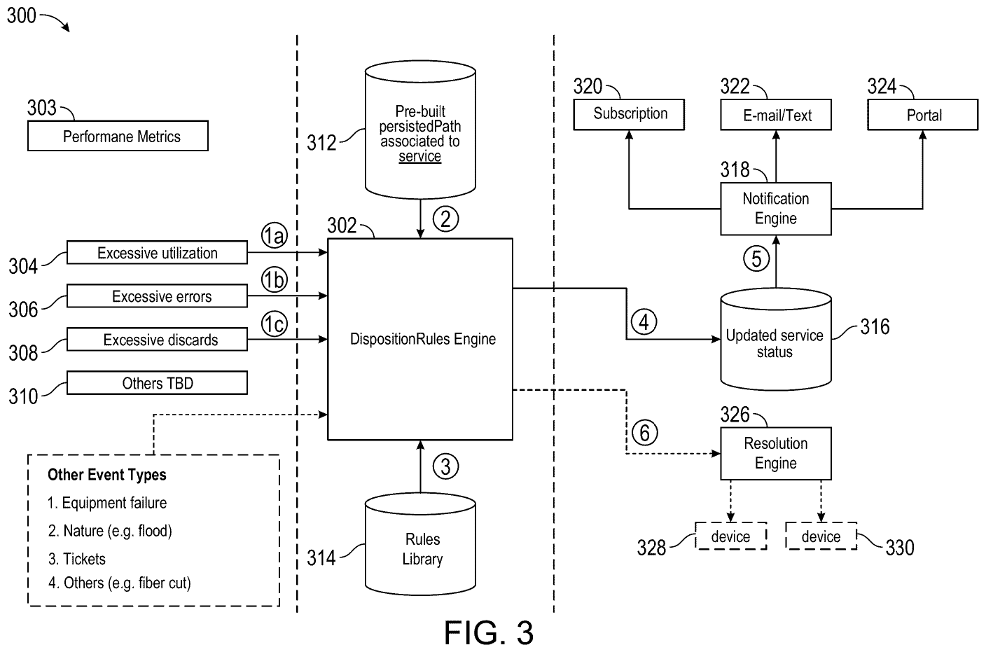

FIG. 3 illustrates an exemplary system 300 for event-driven service health assessment using persistent paths in the communications network 100 of FIG. 1 in accordance with one embodiment.

Referring to FIG. 3, the system 300 may include a disposition/rules engine 302 that receives performance metrics 303, such as excessive utilization 304, excessive errors 306, excessive discards 308, and other performance metrics 310 (e.g., equipment failure, natural events, service tickets, fiber cuts, etc.). Based on pre-built persistent paths to an associated service, as stored in a data storage 312 (e.g., corresponding to the data storage 230 of FIG. 2) and a rules library 314, the disposition/rules engine 302 may determine an updated service status, to be stored in data storage 316, for a given service identifier. The updated service status may be provided to a notification engine 318, which may provide notifications using a subscription 320, email/text message 322, and/or a portal 324. In addition, a resolution engine 326 may resolve issues with a service (e.g., service 328, service 330) based on issues identified by the disposition/rules engine 302.

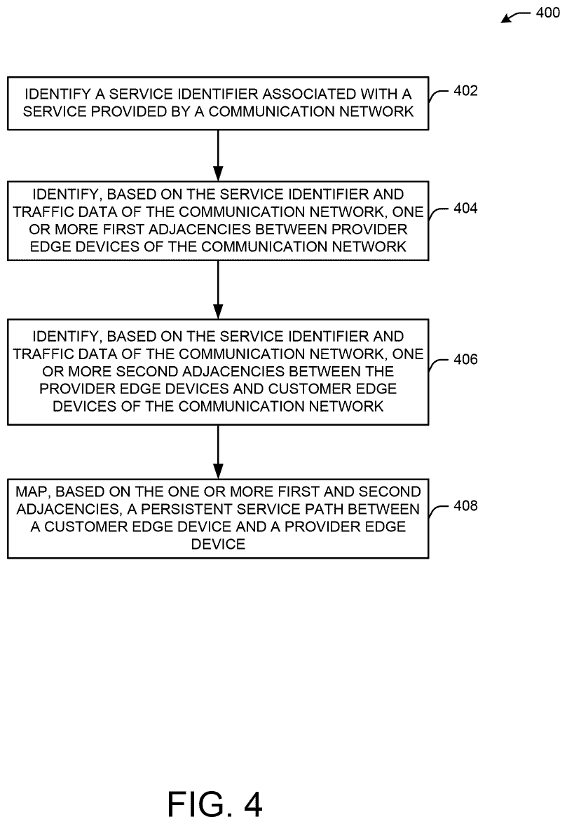

FIG. 4 is a flowchart illustrating a process 400 for identifying persistent paths in the communications network 100 of FIG. 1 in accordance with one embodiment.

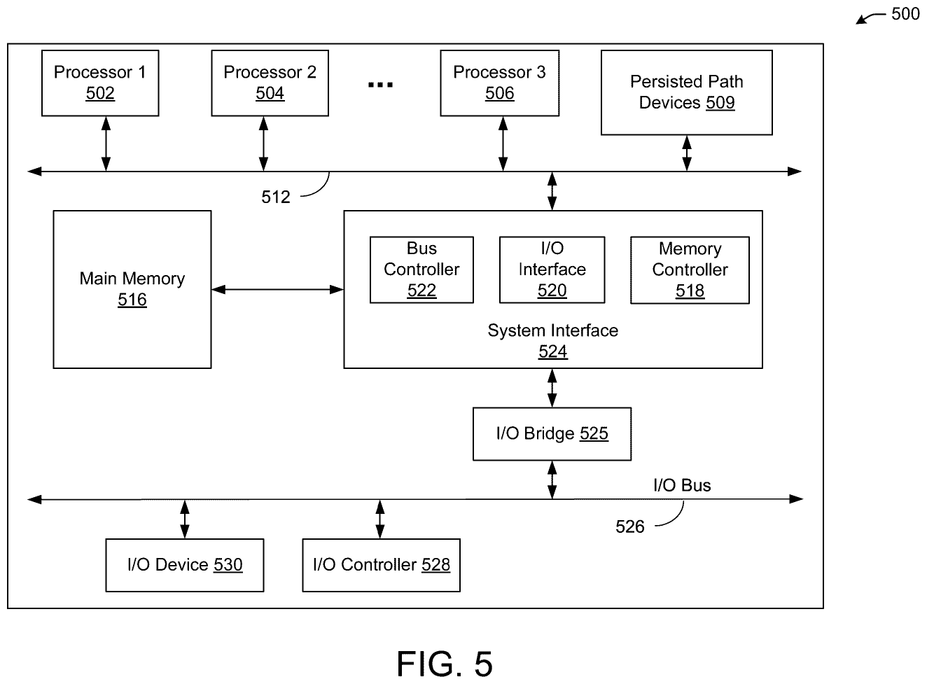

At block 402, a device (or system, e.g., the communications network 100 of FIG. 1, the disposition/rules engine 302 of FIG. 3, the persisted path devices 509 of FIG. 5) may identify a service identifier (e.g., access identifier of FIG. 2) for a service provided by a communications network to one or more customer edge devices.

At block 404, the device may identify, based on the service identifier and traffic data of the communication network, one or more first adjacencies between provider edge devices of the communication network. For example, the one or more first adjacencies may include ma_to_me, mc_to_me, mc_to_ma, and/or mo_to_nid, for some examples (other examples are provided herein).

At block 406, the device may identify, based on the service identifier and traffic data of the communication network, one or more second adjacencies between the provider edge devices and customer edge devices of the communication network. For example, the second adjacencies may include pe_mcpe adjacencies. Referring to blocks 404 and 406, the adjacencies may be identified for each mcRt cluster member, which may be determined based on clusters generated by pe_to_mc adjacencies, mc_to_mc adjacencies, and mcRt_to_members (e.g., cluster member) adjacencies in which the non-cluster members may be removed based on filtering criteria.

At block 408, the device may map, based on the one or more first and second adjacencies, a persisted service path between a customer edge device and a provider edge device. The persisted path may be mapped without a user request (e.g., not at runtime). In this manner, the process 400 may not be user-requested, and the persisted path may be pre-built and stored (e.g., for use by the disposition/rules engine 302 of FIG. 3).

It is understood that the above descriptions are for purposes of illustration and are not meant to be limiting.

FIG. 5 is a block diagram illustrating an example of a computing device or computer system 500 which may be used in implementing the embodiments of the components of the network disclosed above. For example, the computing system 500 of FIG. 5 may represent at least a portion of the communications network 100 of FIG. 1, and discussed above. The computer system (system) includes one or more processors 502-506 and one or more persisted path devices 509 (e.g., representing at least a portion of the communication network 100 of FIG. 1, and/or the rules/disposition engine 302, capable of performing any operations described with respect to FIGS. 1-4). Processors 502-506 may include one or more internal levels of cache (not shown) and a bus controller 522 or bus interface unit to direct interaction with the processor bus 512. Processor bus 512, also known as the host bus or the front side bus, may be used to couple the processors 502-506 with the system interface 524. System interface 524 may be connected to the processor bus 512 to interface other components of the system 500 with the processor bus 512. For example, system interface 524 may include a memory controller 518 for interfacing a main memory 516 with the processor bus 512. The main memory 516 typically includes one or more memory cards and a control circuit (not shown). System interface 524 may also include an input/output (I/O) interface 520 to interface one or more I/O bridges 525 or I/O devices with the processor bus 512. One or more I/O controllers and/or I/O devices may be connected with the I/O bus 526, such as I/O controller 528 and I/O device 530, as illustrated.

I/O device 530 may also include an input device (not shown), such as an alphanumeric input device, including alphanumeric and other keys for communicating information and/or command selections to the processors 502-506. Another type of user input device includes cursor control, such as a mouse, a trackball, or cursor direction keys for communicating direction information and command selections to the processors 502-506 and for controlling cursor movement on the display device.

System 500 may include a dynamic storage device, referred to as main memory 516, or a random access memory (RAM) or other computer-readable devices coupled to the processor bus 512 for storing information and instructions to be executed by the processors 502-506. Main memory 516 also may be used for storing temporary variables or other intermediate information during execution of instructions by the processors 502-506. System 500 may include a read only memory (ROM) and/or other static storage device coupled to the processor bus 512 for storing static information and instructions for the processors 502-506. The system outlined in FIG. 5 is but one possible example of a computer system that may employ or be configured in accordance with aspects of the present disclosure.

According to one embodiment, the above techniques may be performed by computer system 500 in response to processor 504 executing one or more sequences of one or more instructions contained in main memory 516. These instructions may be read into main memory 516 from another machine-readable medium, such as a storage device. Execution of the sequences of instructions contained in main memory 516 may cause processors 502-506 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 506 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 516, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

What is claimed:

1. A method of determining persistent service paths between provider edge devices and customer edge devices, the method comprising:
identifying, by at least one processor of a device, a service identifier associated with a service provided by a communication network;
identifying, by the at least one processor, based on the service identifier and traffic data of the communication network, one or more first adjacencies between provider edge devices, of the communication network, using a service indicated by the service identifier;
identifying, by the at least one processor, based on the service identifier and traffic data of the communication network, one or more second adjacencies between the provider edge devices and customer edge devices using the service; and
mapping, by the at least one processor, based on the one or more first adjacencies and the one or more second adjacencies, a persistent service path between a customer edge device of the customer edge devices and a provider edge device of the provider edge devices.

2. The method of claim 1, wherein the first adjacencies comprise a metro core to a metro edge adjacency.

3. The method of claim 1, wherein the first adjacencies comprise a metro core to a metro aggregator adjacency.

4. The method of claim 1, wherein the first adjacencies comprise a metro off-network to network interface adjacency.

5. The method of claim 1, wherein the first adjacencies comprise a ma to metro edge adjacency.

6. The method of claim 1, wherein the mapping is performed without a user request.

7. The method of claim 1, wherein the first adjacencies and the second adjacencies are based on each metro core cluster member of a cluster of metro core cluster members.

8. The method of claim 7, further comprising generating the cluster of metro core cluster members based on third adjacencies between the provider edge devices and a metro core.

9. The method of claim 8, wherein generating the cluster comprises removing non-cluster members identified using metro core to metro core adjacencies and metro core to member adjacencies.

10. A device for determining persistent service paths between provider edge devices and customer edge devices, the device comprising memory coupled to at least one processor, wherein the at least one processor is configured to:
identify a service identifier associated with a service provided by a communication network;
identify, based on the service identifier and traffic data of the communication network, one or more first adjacencies between provider edge devices, of the communication network, using a service indicated by the service identifier;
identify, based on the service identifier and traffic data of the communication network, one or more second adjacencies between the provider edge devices and customer edge devices using the service; and
map, based on the one or more first adjacencies and the one or more second adjacencies, a persistent service path between a customer edge device of the customer edge devices and a provider edge device of the provider edge devices.

11. The device of claim 10, wherein the first adjacencies comprise a metro core to a metro edge adjacency.

12. The device of claim 10, wherein the first adjacencies comprise a metro core to a metro aggregator adjacency.

13. The device of claim 10, wherein the first adjacencies comprise a metro off-network to network interface adjacency.

14. The device of claim 10, wherein the first adjacencies comprise a ma to metro edge adjacency.

15. The device of claim 10, wherein the mapping is performed without a user request.

16. The device of claim 10, wherein the first adjacencies and the second adjacencies are based on each metro core cluster member of a cluster of metro core cluster members.

17. The device of claim 16, wherein the at least one processor is further configured to generate the cluster of metro core cluster members based on third adjacencies between the provider edge devices and a metro core.

18. The device of claim 17, wherein to generate the cluster comprises to remove non-cluster members identified using metro core to metro core adjacencies and metro core to member adjacencies.

19. A system for determining persistent service paths between provider edge devices and customer edge devices, the system comprising:
the provider edge devices;
the customer edge devices; and
memory coupled to at least one processor, the at least one processor configured to:
identify a service identifier associated with a service provided by a communication network;
identify, based on the service identifier and traffic data of the communication network, one or more first adjacencies between the provider edge devices, wherein the provider edges use a service indicated by the service identifier;
identify, based on the service identifier and traffic data of the communication network, one or more second adjacencies between the provider edge devices and customer edge devices, wherein the customer edge devices use the service; and
map, based on the one or more first adjacencies and the one or more second adjacencies, a persistent service path between a customer edge device of the customer edge devices and a provider edge device of the provider edge devices.

20. The system of claim 19, wherein the first adjacencies comprise a metro core to a metro edge adjacency.
